(19) United States
(12) Patent Application Publication
(10) Pub. No.: US 2007/0023332 A1
(43) Pub. Date: Feb. 1, 2007

(54) Automatic supply filtered water adapting system

(76) Inventor: Huan-Chang Fan, Miau-Li Hsien (TW)

Correspondence Address: Huan-Chang Fan, 235 Chung - Ho, Box 8-24, Taipei, TW

(21) Appl. No.: 11/191,203

(22) Filed: Jul. 28, 2005

(51) Int. Cl. B01D 35/14

(52) U.S. Cl. 210/85; 210/94; 210/420; 210/424

(57) ABSTRACT

An automatic supply filtered water adapter has a filter device to filter the inflowing water and a sensing and supplying device to supply filtered water when its sensor senses an object. The adapter comprises an infrared sensing water supplying device and a water filter connected to the water supplying device by a three-way connecting tube equipped with a water flow controlling device, being a spherical valve controlling the flow direction by a switch, whereby the external infrared sensing water supplying device can eject unprocessed water and filtered water without literally touching the adapting system.

### FIELD OF THE INVENTION

The present invention relates to faucets, and more particularly, it is an adapting system to connect to a faucet and to filter the inflowing water and then supply filtered water when its sensor sensed an object.

### BACKGROUND OF THE INVENTION

As the technology improving, not only to avoid the virus and bacteria inflection but also to make live more covenant, many products use sensing device to become touch-free product. For example, automatic faucets were invented to replace some traditional faucets. Automatic faucets can supply water when somebody puts his hands under the adapting system and automatically stop supplying water when the hands move away.

The adapting system used in families disclosed by U.S. Pat. No. 6,420,737, External infrared rays control switch device for controlling output water on faucets, can be mounted onto a regular faucet and has a sensing region around the control switch device that can senses the intrusion of a hand, thereby activating an outflow of water from the control switch device. The invention has the advantage of swift installation and therefore may reduce the cost of replacing traditional faucet into automatic faucet.

However, there are drawbacks of the previous invention, need further improvement. Such as the original invention has no filter device to purify water that might be polluted by the water supply system, for examples, old or dirty water pipes, water conduits, water towers or even standpipes.

### SUMMARY OF THE INVENTION

The overcome the prior art defect, the present invention provides an automatic supply filtered water adapting system has a filter device to filter the inflowing water and a sensing and supplying device to supply filtered water when an object is located to be sensed. The adapting system comprises an infrared sensing water supplying device, a three-way connecting tube and a filter device connected to the axial terminal of the connecting tube. The transverse section of the connecting tube is for the insertion of an external running water tube. Thereby, a user can rotate a switch to control a spherical vale within the three-way connecting tube to either guide the unprocessed water out of a first water outlet thereon or guide the water into the filter device so as to get a combination of unprocessed water and filtered water out of the filter device. The adapting system can be used as an adapting system in a kitchen or a bathroom. The adapting system is has the advantages that it is more versatile and convenient to a user, given its infrared sensing function.

The various objects and advantages of the present invention will be more readily understood from the following detailed description when read in conjunction with the appended drawings.

### BRIEF DESCRIPTION OF THE DRAWINGS

FIG. 1 is an exploded perspective view of an adapting system according to the present invention.

FIG. 1-1 is a cross sectional view of the connecting tube of the adapting system in FIG. 1.

FIG. 2 is a perspective view of the adapting system in FIG. 1.

FIG. 3 illustrates the flow direction of the filtered water of the adapting system in FIG. 1.

FIG. 4 illustrates the flow direction of the unprocessed water of the adapting system in FIG. 1.

FIG. 5 illustrates the flow direction of the unprocessed water of the second preferred embodiment of the present invention.

FIG. 6 is a cross sectional view of the water controlling unit of the adapting system in FIG. 5.

FIG. 7 illustrates the flow direction of the filtered water of the adapting system in FIG. 5.

FIG. 8 is a cross sectional view of the water controlling unit of the adapting system in FIG. 7.

### DETAILED DESCRIPTION OF THE PREFERRED EMBODIMENTS

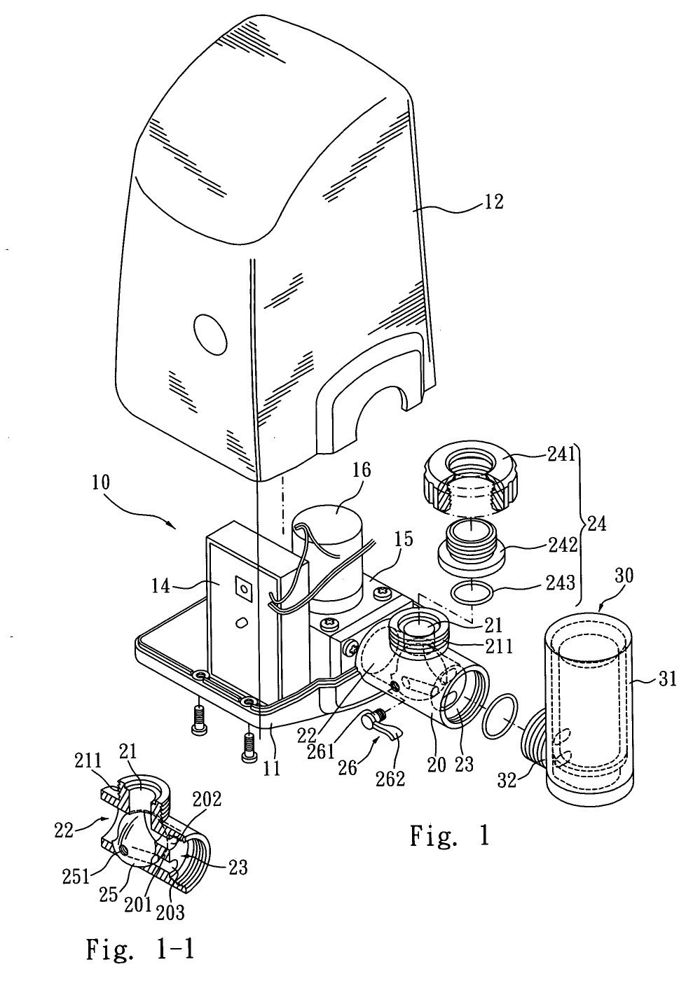

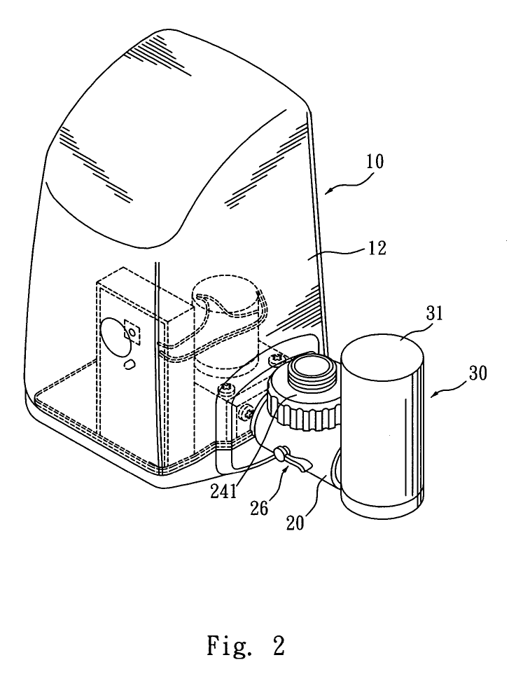

Referring to FIGS. 1, 2 and 1-1, a adapting system used as an automatic water supplying device attached with a filter device according to the present invention comprises infrared sensing water supplying device 10, a three-way connecting tube 20 and a filter device 30.

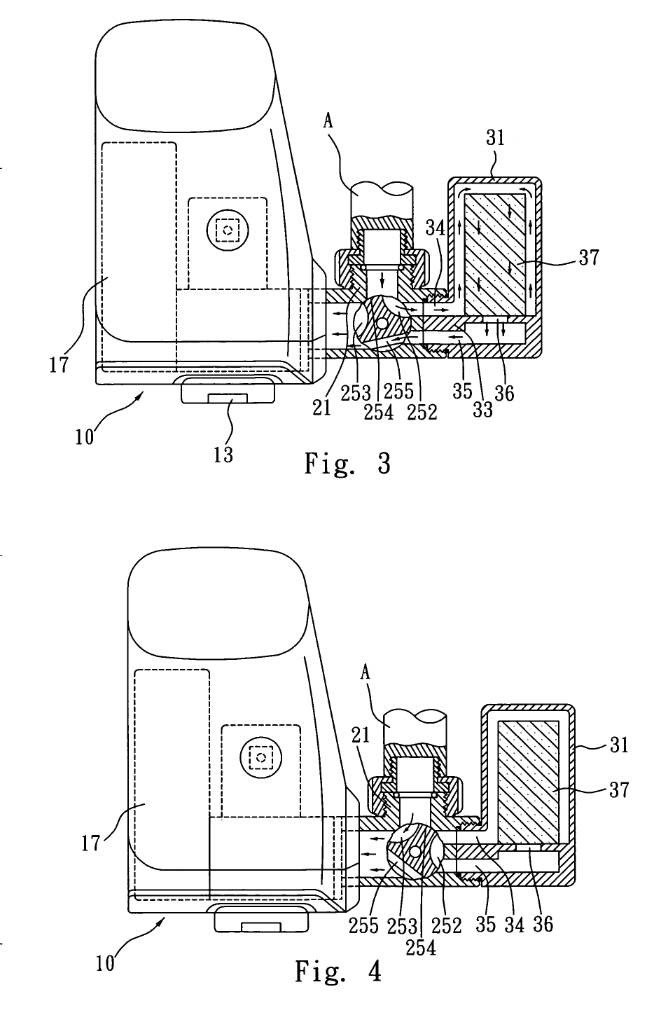

The infrared sensing water supplying device 10 further includes a mount 11 and an upper cover 12. Referring to FIG. 3 and 4, the mount 11 is provided with a first water outlet 13 having a hole opened on the bottom face of the mount 11, An electric controller 14, a water valve 15, an electromagnetic valve 16 and a power supply 17 are housed in the space between the mount 11 and the upper cover 12. The electric controller 14 is further provided with an infrared sensing unit (not shown in the figures), whereby an infrared light beam emitted from the unit will be reflected by a hand extended under the unit, consequently activating the electromagnetic valve 16 and controlling the open/closure of the water valve 15. Inside the water valve 15, there is a three-way water passage, having the three ports respectively connected to the electromagnetic valve 16, the first water outlet 13 and itself.

The T-shaped connecting tube 20 comprises a transverse water inlet terminal 21 on top thereof and two axially openings extended perpendicular to transverse water inlet terminal 21, each connected to the second water outlet 22 of the water valve 15 and a filtered water inlet 23 having a screw thread for engaging the filtering device.

Further, the transverse water inlet terminal 21 is a round projected body on the upper end face of the connecting tube 20. There is an axially extended water inlet in the round projected body. The outer rim of the projected body is provided with an outer screw thread for the engagement of a screwed locking set 24. Thereby, a water tube A can be secured by the outer screw thread 211 around the outer rim of the round projected body to the screwed locking set 24. The screwed locking set 24 further comprises a screwed nut cap 241, a T-shaped connecting member 242 and an O ring 243 for preventing water leakage.

Further, the three-way connecting tube 20 contains a water control unit, which includes a spherical valve 25 right below the transverse water inlet terminal 21 of the connecting tube 20 and a switch 26 going through and fixed at the spherical valve 25.

Thereby, the spherical valve 25 divides the inner space of the three-way connecting tube 20 into a right channel and a left channel. A water divider is extended within the connecting tube 20 from the rear end of the inner thread of the to filtered water inlet 23 over a predetermined length. The divider supports against the spherical valve 25 and further includes an upper through hole and a lower through hole, which divide the right water channel into respectively an upper water channel 202 and a lower water channel 203. The stopper 201 separated upper water channel 202 and lower water channel 203.

Further, the surface of one side of the spherical valve 25 is provided with a screwed hole 251, whereas the end face of the connecting tube 20 corresponding to the screwed hole 251 is provided with another screwed hole, which will facilitate the connection between a connecting rod 261 in the front of the switch 26 and the connecting tube 20. Therefore, the spherical valve 25 within the receptacle space will be secured, whereby a user can rotate a switch handle 262 of the switch 26 and control the direction of water flow of the water inlet terminal 21.

The switch 26 plays an important role in controlling the direction of water flow of the inlet terminal 21. Water flows in and is separated into a first water channel 252 and a second water channel 253 by a water blocking projection 254 located between these two water channels.

FIGS. 3 and 4 illustrate the effect of the water channels and the water block. Referring first to FIG. 3, as the switch 26 of the spherical valve 25 is rotated counter-clockwise, the water blocking projection 254 in the upper portion of the spherical valve 25 blocks the left side of the inlet terminal 21, whereby the first water channel 252 will connect the upper water channel 202 and water will flow through the upper water channel 202 into the filter device 30. Further, water filtered by the filter device 30 will flow through the lower water channel 203 toward a water guide 255 in the lower portion of the spherical valve 25, then being ejecting from the first water outlet 13.

Referring to FIG. 4, as the switch 26 of the spherical valve 25 is rotated clockwise, the water block 254 in the upper portion of the spherical valve 25 blocks the right side of the inlet terminal 21, whereby the first water channel 252 will disconnect the upper water channel 202 and water will flow through the second water channel 253, not passing the filter device 30. Unprocessed water filtered will flow out of the first water outlet 13.

Referring to FIGS. 1, 3 and 4, the above-disclosed filter device 30 comprises a main body 31 and a connector 32; the connector 32 has an outer screw thread thereon for engaging the inner screw thread on the filtered water inlet 23 of the connector 32. Further, at a predetermined location in the inner bottom portion of the main body 31, there is a water divider 33 extended for a predetermined length and thickness, for separating the water flow therein into a unprocessed water channel 34 and a processed water channel 35. The unprocessed water channel 34 and the processed water channel 35 are connected by a through hole 36 on the water divider 33. Above the water divider 3, there is a bulk of filtering material 37. Between the inner upper surface and the upper end of the filtering material 37, there exists a raw water passage for passing the unprocessed water. The water, being filtered by the filter device 30, flows into the through hole 36 on the water divider 33 and then into the processed water channel 35.

Referring to FIGS. 3 and 4, as the switch 26 is rotated counter-clockwise so as to drive the spherical valve 25, the water from the inlet terminal 21 will follow through the first water channel 252 and then be guided to the upper water channel 202. The upper water channel 202 directs water in the unprocessed water channel 34 into the filter device 30, whereby the germs and impurities in the water will be removed. The filtered water flows out of the bottom of the filtering material 37 and is collected by the processed water channel 35. The processed water is then guided into lower water channel 203, the guide hole 255 of the spherical valve 25, then being ejected from the second water outlet 22. When a hand is intruding in the range of the infrared sensing unit, the reflected infrared beam will activate the electric controller 14 and then the electromagnetic valve 16, whereby filtered water out of the second water outlet 22 will be ejected from the first water outlet 13 of the adapting system through the water valve 15.

Referring to FIG. 4, as the switch 26 is rotated clockwise so as to drive the spherical valve 25, the water from the inlet terminal 21 will follow through the second water channel 253 and then be guided directly to the first water outlet 13. When a hand is intruding in the range of the infrared sensing unit, the reflected infrared beam will activate the electric controller 14 and then the electromagnetic valve 16, whereby the unprocessed water will be ejected from the first water outlet 13 of the adapting system through the water valve 15.

The present invention is a compact adapting system capable of being directly attached an external infrared rays control switch device for controlling output water on faucets (U.S. Pat. No. 6,420,737) and it is attached with a water filter device 30 at the same time. Since it is activated by infrared sensing, the present invention can avoid hand touching and germ pollution. It can be swiftly mounted onto a regular faucet and convert the faucet into an automatic sensing faucet, without replacing the old one.

No matter the filtered water or the unprocessed raw water, they all come out of the first water outlet 13 on the mount 11 of the adapting system, therefore avoiding the traditional structure of the previous invention and waiving the extra cost.

Further, the filter device 30 and the connecting tube 20 are connected by screw threads carved on respective engaged ends. When the filtering material 37 is depleted, it can be replaced to continue the service of the filter device 30.

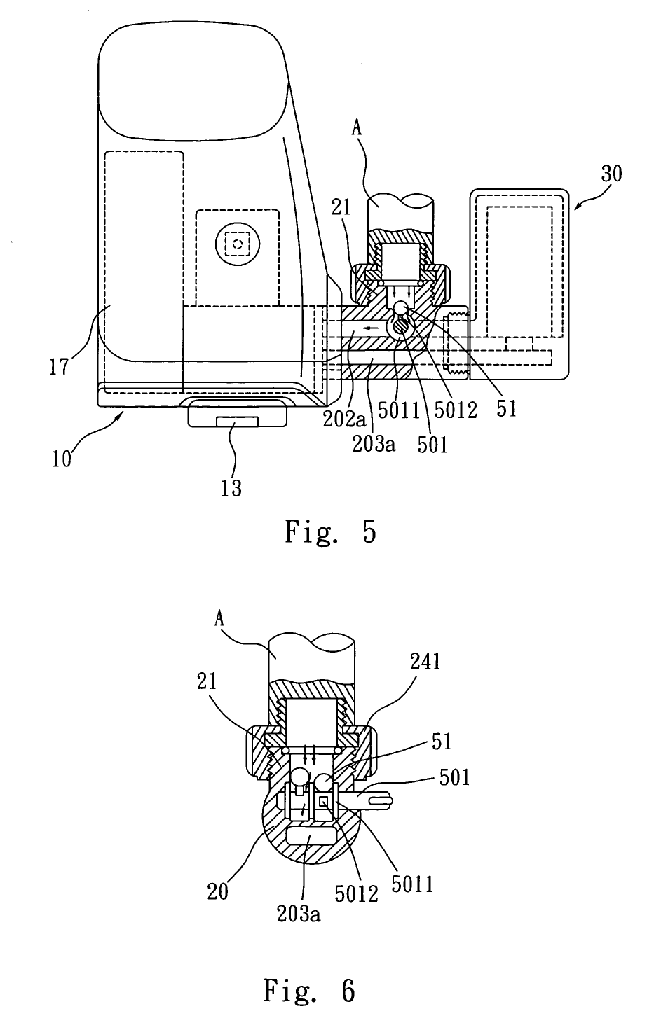

Referring to FIGS. 5 to 8, the second preferred embodiment of the present invention is similar to the first preferred embodiment, except for the difference in spatial structure. The same components of sensing water supplying device, filter device and the connecting tube will not be further described. The following paragraphs particularly describe the flow control unit and a different design in the connecting tube.

The connecting tube 20 of this preferred embodiment has a stopper 201a, which will divide the axial flow passage within the connecting tube 20 into an upper water channel 202a and a lower water channel 203a. The upper water channel 202a is aligned to the transverse water inlet, forming a perpendicular crossing and a round hole therein. The upper water channel 202a is further divided into a left water channel and a right water channel. The inner wall of the round hole has two retaining holes arranged in the radial direction for securing the upper water channel 202a.

The flow control unit comprises a switch 50 and two spherical objects 51; the switch 50 consists of a connecting rod 501 with a cross section smaller than the round hole and a switch handle 502. The connecting rod 501 has a second round hole aligned to the two retaining holes on the round hole, wherein the cross section of the second round hole is divided into a three deck by three spherical dividers 5011. The three dividers thereby define two zones, each of the zones being provided with a rib structure 5012.

Further, the three dividers 5011 extended from in the front of the connecting rod will divide the two retaining holes into isolated retaining holes, for housing respectively the spherical objects 51. Each of the spherical objects 51 may close the retaining holes, which spherical objects will be lifted and opened by the rib structure 5012 of the connecting rod 501 by the rotation of the switch 50. Thereby, the water from the first inlet will be guided into either of the left and right water channels.

Referring to FIGS. 5 and 6, as the switch handle 502 of the switch 50 is rotated counter-clockwise, the rib structure 5012 on the left zone of the connecting rod will lift the associated spherical object 51, whereby there will be a slit between the spherical object 51 and the associated retaining hole and the water from the first inlet will be guided into the left water channels and then the first water outlet as unprocessed water.

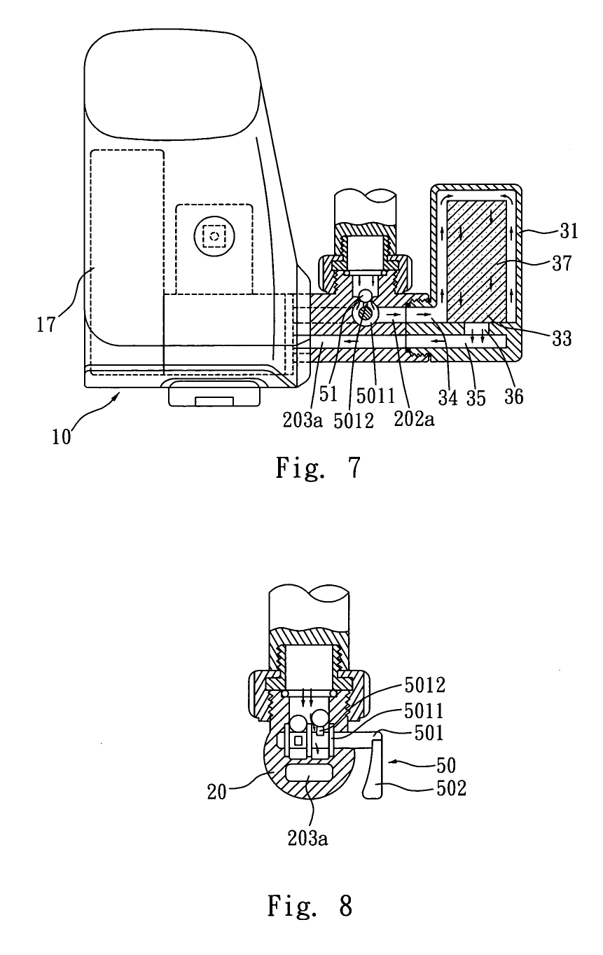

On the other hand, referring to FIGS. 7 and 8, as the switch handle 502 of the switch 50 is rotated clockwise back to its original configuration, the rib structure 5012 on the right zone of the connecting rod will lift the associated spherical object 51, whereby there will be a slit between the spherical object 51 and the associated retaining hole and the water from the first inlet will be guided into the right water channels and then into the filter device 30. In the filter device 30, the raw is processed by the filtering material 37 and guided into the filtered water channel and then the lower water channel. Eventually, the water will be ejected from the first water outlet as unprocessed water. The preferred embodiment utilizes the switch 50 and the rib structure in the font of the connecting rod to assure a two-way switching mechanism for switching water between an unprocessed state and a filtered state.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An adapting system, used as an automatic water supplying device of a filter device, comprising:
a sensing water supplying device having an inner receptacle housing an electric controller, an infrared sensing unit, a water valve and a power supply;
a three-way connecting tube connected to a lateral side of said sensing water supplying device, said connecting tube taking a T shape and being provided with an internal flow passage, said connecting tube further including a primacy water outlet on an inner wall therein and two water ports at two ends along an axial direction, said ports being respectively a water inlet; and
a filter device screwing to the water outlet and further comprising a longitudinal main body and a transverse connector, said filter device being connected to said secondary water outlet by screw threads of engaging sections respectively of said connecting tube and said transverse connector, said main body consisting of a filtering material, at upper ends and lower ends of said main body and said transverse connector, there being respectively unprocessed water channels and filtered water channels.

2. The adapting system of claim 1, wherein said connecting tube taking a T shape and being provided a spherical valve controlling the direction of flows by a switch which is connected to external device.

3. The adapting system of claim 2 wherein a hole with a screw thread forms on one side of said spherical vale for securing said switch; two opposite lateral sides in an upper portion of said spherical valve are each provided with a water channel; a water blocking projection being on a said spherical valve's surface; a guiding hole being formed transversely through a lower portion of said spherical valve.

4. The adapting system of claim 1 wherein said filtered water outlet of said T-shaped connecting tube is provided with a screw thread on an inner wall of said connecting tube; said connecting tube further including a water blocking plate located near said inner screw thread at a predetermined distance for defining an upper water channel connected to an unprocessed water channel and a lower channel connected to a filtered water channel.

5. The adapting system of claim 1 wherein a water divider of predetermined thickness is disposed in said main body near a bottom end and extended toward an open of said transverse connector, whereby said filter device is divided into an upper unprocessed water channel and a lower filtered water channel; said two upper and lower water channels are connected by an opening; said filter situating right above said opening of said filter device.

6. An adapting system, used as an automatic water supplying device of a filter, comprising:
a sensing water supplying device having an inner receptacle housing an electric controller, an infrared sensing unit, a water valve and a power supply;
a three-way connecting tube connected to a lateral side of said sensing water supplying device, said connecting tube taking a T shape and being provided with an internal flow passage and a flow control unit, said connecting tube further including a primacy water outlet on an inner wall therein and two water ports at two ends along an axial direction, said ports being respectively a water inlet and a secondary water outlet; and
a filter device further comprising a longitudinal main body and a transverse connector, said filter device being connected to said secondary water outlet by screw threads of engaging sections respectively of said connecting tube and said transverse connector, said main body consisting of a filtering material, at upper ends and lower ends of said main body and said transverse connector, there being respectively unprocessed water channels and filtered water channels.

7. The adapting system of claim 6 wherein said filtered water terminal of said T-shaped connecting tube is provided with an inner screw-threaded section; between said filtered water terminal and a center portion said water outlet, there being a water divider for separating the water passage into a lower water channel and an upper water channel; a round hole being formed between said upper water channel and an associated water inlet, whereby said upper water channel on one side of said round hole will be connected to said unprocessed water channel, and whereby said lower water channel, and the filtered water channel and the water outlet will be connected.

8. The adapting system of claim 6 wherein said flow control unit further comprises a switch and two spherical objects.

9. The adapting system of claim 8 wherein said round hole is for the insertion of a connecting rod of the switch; an inner wall of said round hole having two retaining holes arranged in the radial direction; said connecting rod having three dividing plates aligned to said round hole; said three dividing plates defining two zones with a width the same as the caliber of said retaining holes; said zones being respectively provided with rib structures that are not straightly extended; said rib structures can change the locations of said spherical objects within said retaining holes.
